(19) United States
(12) Patent Application Publication
(10) Pub. No.: US 2026/0211434 A1
(43) Pub. Date: Jul. 23, 2026

(54) LINKAGE-TYPE CONSTANT-PRESSURE VALVE

(71) Applicant: ASAHI YUKIZAI CORPORATION, Nobeoka-shi, Miyazaki (JP)

(72) Inventors: Kenro YOSHINO, Nobeoka-shi, Miyazaki (JP); Hiroshi SUENAGA, Nobeoka-shi, Miyazaki (JP)

(21) Appl. No.: 19/139,871

(22) PCT Filed: Dec. 22, 2023
(86) PCT No.: PCT/JP2023/046228

§ 371 Date: Jun. 17, 2025

(30) Foreign Application Priority Data
Dec. 23, 2022 (JP) 2022-206776

(51) Int. Cl. G05D 16/06

(52) U.S. Cl. CPC G05D 16/0636; G05D 16/0641

(57) ABSTRACT

A constant-pressure valve includes: a valve main body in which are formed a first valve chamber and a second valve chamber that are in communication via a communication path; a valve mechanism which includes a first diaphragm that supports a valve body part in a first valve chamber in a manner enabling contact/separation with/from a valve seat formed in the communication path, and a second diaphragm that faces the second valve chamber, a first force-applying mechanism; and a second force-applying mechanism. The first force-applying mechanism is provided with a first moving body that is biased by a biasing member and joined to the valve body part via a stem. The second force-applying mechanism is provided with a second moving body to which a force is applied by an applied force adjustment mechanism and to which is transmitted fluid pressure in the second valve chamber that acts on the second diaphragm. A link member that extends to the outside of a fluid contact region links the two moving bodies.

### TECHNICAL FIELD

The present invention relates to a constant-pressure valve provided with a diaphragm, which is used to suppress fluctuations in fluid pressure when transferring various fluids in various industrial fields, such as a semiconductor manufacturing field, chemical factories, and a food field.

### BACKGROUND ART

Conventionally, in semiconductor manufacturing and the like, a constant-pressure valve provided with two diaphragms such as disclosed in PTL1 has often been used to achieve high-accuracy stability in fluid pressure control.

FIG. 9 shows a conventional fluid control valve 300 as an example of such a constant pressure valve, which fluid control valve 300 includes: a main body 306 having a first valve chamber 301, a second valve chamber 302, a communication hole 303 of a smaller diameter than the first valve chamber 301 and the second valve chamber 302 for allowing communication between the two valve chambers, an outlet flow passage 304 which is in communication with the first valve chamber 301, and an inlet flow passage 305 which is in communication with the second valve chamber 302; a bonnet 310 having a cavity 309 which accommodates a piston 307 and a spring 308 therein; a first valve mechanism body 312 having a first diaphragm 311 connected to a lower portion of the piston 307 and covering the first valve chamber 301; a second valve mechanism 315 connected to the first valve mechanism body 312 and having a valve element 314 provided with a second diaphragm 313 at the lower end thereof; and a base plate 316 which is located below the main body 306 and holds the second diaphragm 313 between the main body 306 and the base plate 316. The valve element 314 comes into and out of contact with a valve seat 317 formed on an upper surface portion of the second valve chamber 302 to open and close the communication hole 303. Compressed air is supplied to the cavity 309 through an intake hole 318. The valve element 314 of the second valve mechanism 315 is pushed upward by a repulsive force of the spring 308 held between a flange part 319 of the piston 307 and a spring bearing 320 and the pressure of the fluid in the first valve chamber 301 acting on a lower surface of the first diaphragm 311 of the first valve mechanism body 312, while being pushed downward by the pressure of the compressed air in the cavity 309 acting on an upper surface of the first diaphragm 311. Further, although a lower surface of the valve element 314 and an upper surface of the second diaphragm 313 of the second valve mechanism 315 are subjected to the pressure of the fluid, the forces are almost offset because their pressure-receiving areas are approximately equal. Therefore, the valve element 314 comes to a halt at a position where the above-described three forces are balanced.

Therefore, when the pressure in the first valve chamber 301 on the downstream side increases, the force that the lower surface of the first diaphragm 311 receives from the fluid becomes greater than the force that the upper surface of the first diaphragm 311 receives from the compressed air, so that the first diaphragm 311 moves upward. Since the position of the valve element 314 also moves upward along with this, the opening area between the valve element 314 and the valve seat 317 decreases, reducing the pressure in the first valve chamber 301, and the valve element 314 stops when the valve element 314 moves to a position where the above-described three forces are balanced. If the biasing force of the spring 308 does not change significantly, the pressure inside the cavity 309, or the force received by the upper surface of the first diaphragm 311, remains unchanged, so that the pressure in the first valve chamber 301 becomes the same as the pressure before the change.

On the other hand, when the pressure in the first valve chamber 301 on the downstream side decreases, the force that the lower surface of the first diaphragm 311 receives from the fluid becomes smaller than the force that the upper surface of the first diaphragm 311 receives from the compressed air, so that the first diaphragm 311 moves downward. Since the position of the valve element 314 also moves downward along with this, the opening area between the valve element 314 and the valve seat 317 increases, increasing the pressure in the first valve chamber 301, and the valve element 314 stops when the valve element 314 moves to a position where the above-described three forces are balanced. As a result, as in the case where the pressure in the first valve chamber 301 increases, the fluid pressure in the first valve chamber 301 becomes the same as the pressure before the change. Fluctuations in the pressure of the fluid on the downstream side are suppressed in this way.

### CITATION LIST

### Patent Literature

PTL 1: Japanese Unexamined Patent Publication No. 2004-38571

### SUMMARY OF THE INVENTION

### Technical Problem

In the fluid control valve 300 as shown in FIG. 9, it is common practice that shaft portions extending from the first diaphragm 311 and the second diaphragm 313 are connected to the valve element 314 in order to allow the first diaphragm 311 and the second diaphragm 313 to move in conjunction with the valve element 314. However, since the valve element 314 is larger than the communication hole 303 that extends from the valve seat 317 and communicates the first valve chamber 301 and the second valve chamber 302 with each other, it is often the case, for convenience of assembly, that the shaft portion of one of the first diaphragm 311 and the second diaphragm 313 is integrally formed with the valve element 314, while the other shaft portion is connected to the valve element 314 via a threaded joint. As a result, there is a threaded portion 321 disposed within a fluid contact region through which fluid flows, so that there is a risk that particles generated during assembly or with the driving of the valve element 314 may be released from the threaded portion 321 and mixed into the fluid, thereby resulting in contamination of the fluid.

Accordingly, it is an object of the present invention to solve the problems existing in the prior art and to provide a constant-pressure valve that suppresses pressure fluctuations by moving two diaphragms in conjunction with each other, without providing a mechanism for moving the two diaphragms in conjunction with each other within a fluid contact region, thereby suppressing the generation of particles in the fluid contact region.

### Solution to Problem

In view of the above object, the present invention provides a linkage-type constant-pressure valve which includes: a valve body formed with a first valve chamber being in communication with an inlet flow passage, a second valve chamber being in communication with an outlet flow passage, and a communication passage communicating the first valve chamber and the second valve chamber with each other; a valve seat formed in the communication passage; a valve mechanism including a first diaphragm attached to the valve body so as to face the first valve chamber and supporting a valve element portion movable in a direction of a movement axis relative to the valve seat, and a second diaphragm attached to the valve body so as to face the second valve chamber; a first force-applying mechanism attached to the valve body and applying a force to the first diaphragm in a direction to bring the valve element portion closer to the valve seat; and a second force-applying mechanism attached to the valve body and applying a predetermined force in a direction to bring the second diaphragm closer to the communication passage, the valve element portion moved relative to the valve seat in accordance with the pressure of a fluid in the second valve chamber, in which the first force-applying mechanism includes a first mechanism housing having a first mechanism accommodating chamber formed therein, a first movable body accommodated in the first mechanism accommodating chamber and movable in the direction of the movement axis, a biasing member provided in the first mechanism accommodating chamber and biasing the first movable body in a direction to approach the communication passage, and a stem extending from the first movable body through the first mechanism housing and connected to the valve element portion of the first diaphragm, in which the second force-applying mechanism includes a second mechanism housing having a second mechanism accommodating chamber formed therein, a second movable body accommodated in the second mechanism accommodating chamber and movable in the direction of the movement axis, an applied force adjustment mechanism applying an adjustable predetermined force to the second movable body in a direction to approach the communication passage, and a force transmission portion extending from the second movable body through the second mechanism housing and transmitting a force between the second movable body and the second diaphragm, and in which a rod-shaped link member is provided so as to be arranged between the first movable body and the second movable body and extend through the valve body outside the first valve chamber and the second valve chamber in the direction of the movement axis, so that the first movable body and the second movable body are moved in conjunction with each other via the link member.

In the above-described linkage-type constant-pressure valve, the first movable body of the first force-applying mechanism, which is movable in the direction of the movement axis, is biased by the biasing member in the direction to approach the communication passage, and the second movable body of the second force-applying mechanism, which is movable in the direction of the movement axis, is applied with the predetermined force in the direction to approach the communication passage by the applied force adjustment mechanism. Further, the link member extending in the direction of the movement axis outside the first valve chamber and the second valve chamber is provided between the first movable body and the second movable body. Since the first movable body and the valve element portion of the first diaphragm are connected to each other via the stem, the valve element portion supported by the first diaphragm is always applied, by the biasing member, with a force in a direction to approach the valve seat formed in the communication passage. Further, the first force-applying mechanism and the second force-applying mechanism are attached to the valve body so as to be able to apply a force to the first diaphragm and the second diaphragm facing the first valve chamber and the second valve chamber, respectively, which are located on opposite sides of the communication passage. The first movable body of the first force-applying mechanism and the second movable body of the second force-applying mechanism are applied with forces in a direction to approach the communication passage by the biasing member and the applied force adjustment mechanism, respectively. That is, the first movable body and the second movable body receive forces in a direction to approach each other along the movement axis, so that the link member is held between the first movable body and the second movable body and the first movable body and the second movable body move in conjunction with each other via the link member in the same direction at the same intervals along the movement axis. Since the force transmission portion extending from the second movable body transmits force between the second movable body and the second diaphragm, the second movable body of the second force-applying mechanism is applied with not only the force applied by the applied force adjustment mechanism, but also the pressure of the fluid in the second valve chamber acting on the second diaphragm via the force transmission portion in a direction to offset the force applied by the applied force adjustment mechanism (i.e., in a direction to move the second movable body away from the communication passage). Accordingly, the first movable body and the second movable body, which move in conjunction with each other via the link member, come to a halt at a position where three forces, i.e., the biasing force applied to the first movable body by the biasing member, the force applied to the second movable body by the applied force adjustment mechanism, and the fluid pressure applied by the fluid in the second valve chamber to the second movable body via the second diaphragm and the force transmission portion, are balanced. Therefore, when the force applied to the second movable body by the applied force adjustment mechanism, which is one of the two forces acting on the second movable body, is adjusted and changed, the position of the first movable body also changes, resulting in a change in the position of the valve element portion relative to the valve seat via the stem. As a result, the opening area between the valve element portion and the valve seat is adjusted and the flow rate from the first valve chamber to the second valve chamber is changed, thereby allowing the fluid to be adjusted to a desired pressure.

Further, under a condition where the force applied to the second movable body by the applied force adjustment mechanism remains constant, when the pressure of the fluid in the second valve chamber increases, the pressure of the fluid in the second valve chamber in a direction to offset the force applied by the applied force adjustment mechanism increases, causing the second movable body to move in a direction away from the communication passage, while when the pressure of the fluid in the second valve chamber decreases, the pressure of the fluid in the second valve chamber in a direction to offset the force applied by the applied force adjustment mechanism decreases, causing the second movable body to move in a direction to approach the communication passage. According to this, the valve element portion, which is connected via the stem to the first movable body moving in conjunction with to the second movable body via the link member, moves in a direction to approach the valve seat to reduce the opening area between the valve seat and the valve element portion when the pressure of the fluid in the second valve chamber increase, and moves in a direction away from the valve seat to increase the opening area between the valve seat and the valve element portion when the pressure in the second valve chamber decreases. As a result, fluctuations in the pressure of the fluid on the downstream side can be suppressed, and the pressure can be kept substantially constant. Further, the link member, which moves the first movable body and the second movable body in conjunction with each other, is disposed outside the first valve chamber and the second valve chamber, making it possible to avoid providing any threaded portions for moving the first diaphragm and the second diaphragm in conjunction with each other within the fluid contact region.

In the above-described linkage-type constant-pressure valve, it is preferable that the applied force adjustment mechanism is configured to apply to the second movable body a force greater than or equal to the pressure exerted by the fluid in the second valve chamber on the second diaphragm.

Further, in the above-described linkage-type constant-pressure valve, it is preferable that a plurality of link members extend between the first movable body and the second movable body.

In one embodiment, the force transmission portion can be configured to come in contact with the second diaphragm and transmit force between the second movable body and the second diaphragm.

In this case, the applied force adjustment mechanism may include a pressurizing fluid chamber and a pressurizing diaphragm provided adjacent to the pressurizing fluid chamber, and can be configured to make the pressure of the pressurizing fluid adjustably supplied into the pressurizing fluid chamber to act on the second movable body via the pressurizing diaphragm.

If the pressure of the pressurizing fluid is made to act on the second movable body via the pressurizing diaphragm, there is no need to provide a seal member for sealing between an outer peripheral surface of the second movable body and an inner peripheral surface of the second mechanism accommodating chamber, thereby making it possible to reduce friction between the outer peripheral surface of the second movable body and the inner peripheral surface of the second mechanism accommodating chamber and improve pressure responsiveness.

The pressurizing fluid is preferably compressed air.

In another embodiment, the force transmission portion can be connected to the second diaphragm.

In this case, the applied force adjustment mechanism may include a recess provided on a surface of the second mechanism housing facing the second diaphragm, and the second diaphragm may cover the recess to form a pressurizing fluid chamber when the second force-applying mechanism is attached to the valve body, and fluid pressure acting on the second diaphragm by a pressurizing fluid adjustably supplied to the pressurizing fluid chamber may be applied to the second movable body via the force transmission portion. Since the second diaphragm and the force transmission portion are connected to each other, the pressure applied to the second diaphragm by the fluid in the pressurizing fluid chamber is transmitted to the second movable body via the force transmission portion, and the force in the direction to approach the first movable body can be made to act on the second movable body. Further, since the force adjusted by the applied force adjustment mechanism is applied directly to the second diaphragm, pressure responsiveness is improved.

The pressurizing fluid is preferably compressed air.

In the above-described linkage-type constant-pressure valve, the biasing member can be, for example, a coil spring.

In one embodiment, the link member may be held between the first movable body and the second movable body to be able to come into and out of contact with the first movable body and the second movable body. Further, in another embodiment, both ends of the link member may be fixed to the first movable body and the second movable body, respectively.

### Advantageous Effects of the Invention

According to the linkage-type constant-pressure valve of the present invention, the first movable body is applied with the resultant force of the two forces acting on the second movable body via the link member, and also with the biasing force acting thereon from the biasing member in a direction to move the second movable body away from the communication passage via the first movable body and the link member, so that the first movable body comes to a halt at a position where these three forces are balanced. Therefore, when the force applied to the second diaphragm by the applied force adjustment mechanism, which is one of the two forces acting on the second movable body is adjusted and changed, the position of the first movable body changes, resulting in a change in the position of the valve element portion relative to the valve seat changes via the stem. Consequently, the degree of opening between the valve element portion and the valve seat is adjusted, so that the fluid can be adjusted to the desired pressure. Also, even if the pressure of the fluid in the second valve chamber increases or decreases, the resultant force of the two forces acting on the second movable body changes, thereby changing the equilibrium position of the first movable body to make it possible to suppress fluctuations in the pressure of the fluid on the downstream side and maintain the pressure substantially constant. Further, the link member which move the first movable body and the second movable body in conjunction with each other is disposed outside the first valve chamber and the second valve chamber, and no threaded portions for moving the first diaphragm and the second diaphragm in conjunction with each other is provided within the fluid contact region, so that screwing work in the fluid contact region is not required. Therefore, assembly can be performed without concerns about contamination of parts located in the fluid contact region, thereby making it possible to facilitate assembly and suppress the generation of particles in the fluid contact region.

### BRIEF DESCRIPTION OF DRAWINGS

FIG. 1 is a plan view of a linkage-type constant-pressure valve according to one embodiment of the present invention.

FIG. 2 is a cross-sectional view taken along line A-A of the linkage-type constant-pressure valve shown in FIG. 1, as viewed from the direction of the arrows.

FIG. 3 is a cross-sectional view taken along line B-B of the linkage-type constant-pressure valve shown in FIG. 1, as viewed from the direction of the arrows.

FIG. 4 is a cross-sectional view taken along line C-C of the linkage-type constant-pressure valve shown in FIG. 1, as viewed from the direction of the arrows.

FIG. 5 is a cross-sectional view taken along line D-D of the linkage-type constant-pressure valve shown in FIG. 1, as viewed from the direction of the arrows, and illustrates a state in which a valve element portion is in a closed position.

FIG. 6 is a cross-sectional view taken along line D-D of the linkage-type constant-pressure valve shown in FIG. 1, as viewed from the direction of the arrows, and illustrates a state in which the valve element portion is in an open position.

FIG. 7 is a cross-sectional view taken along line D-D of the linkage-type constant-pressure valve shown in FIG. 1, as viewed from the direction of the arrows, and illustrates a state in which the valve element portion is in an intermediate position.

FIG. 8 is a cross-sectional view of a linkage-type constant-pressure valve according to another embodiment of the present invention.

FIG. 9 is a cross-sectional view showing an overall configuration of a conventional linkage-type constant-pressure valve.

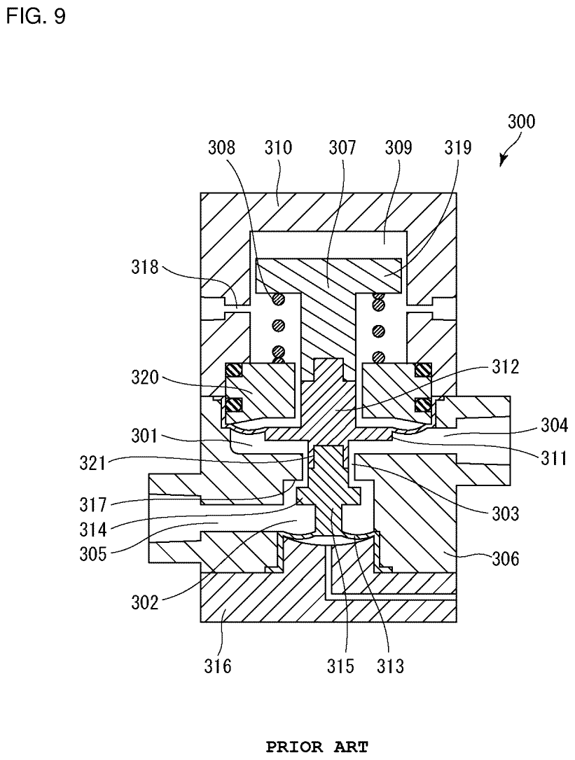

### DESCRIPTION OF EMBODIMENTS

Embodiments of a linkage-type constant-pressure valve according to the present invention will be described below with reference to the drawings.

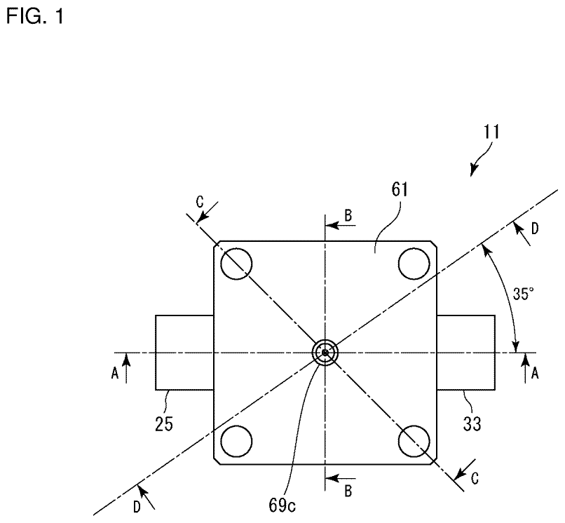

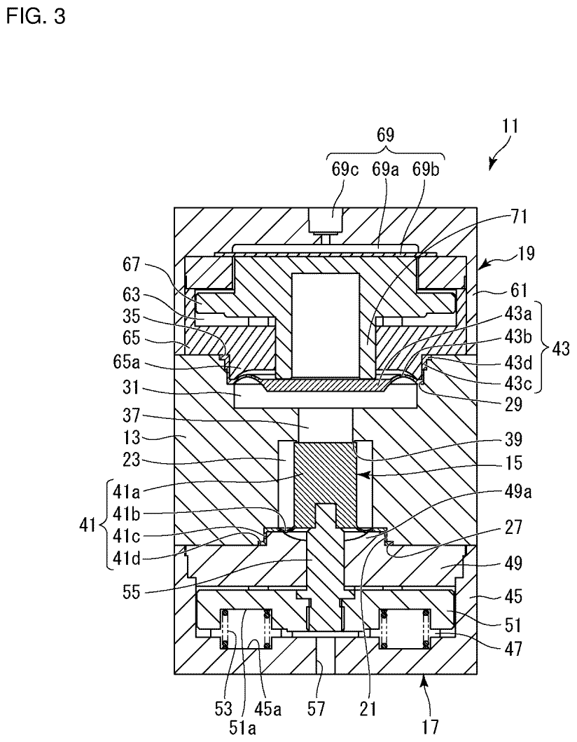

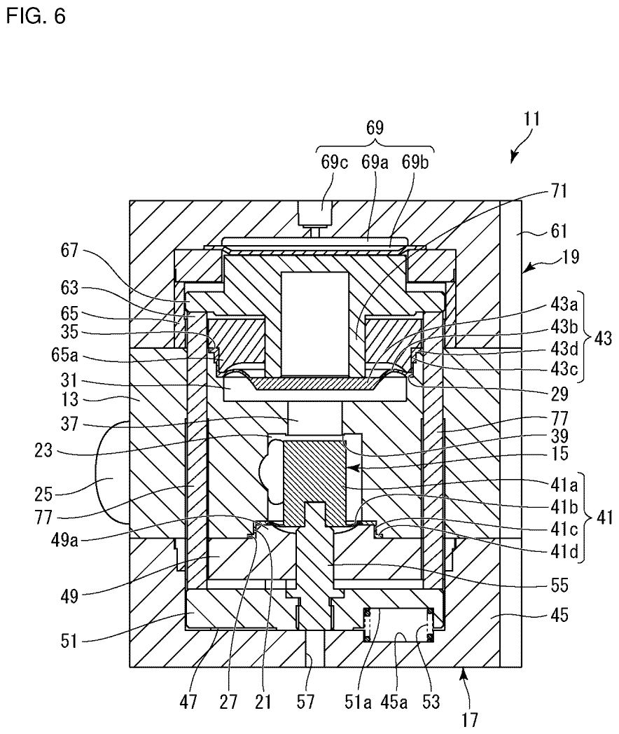

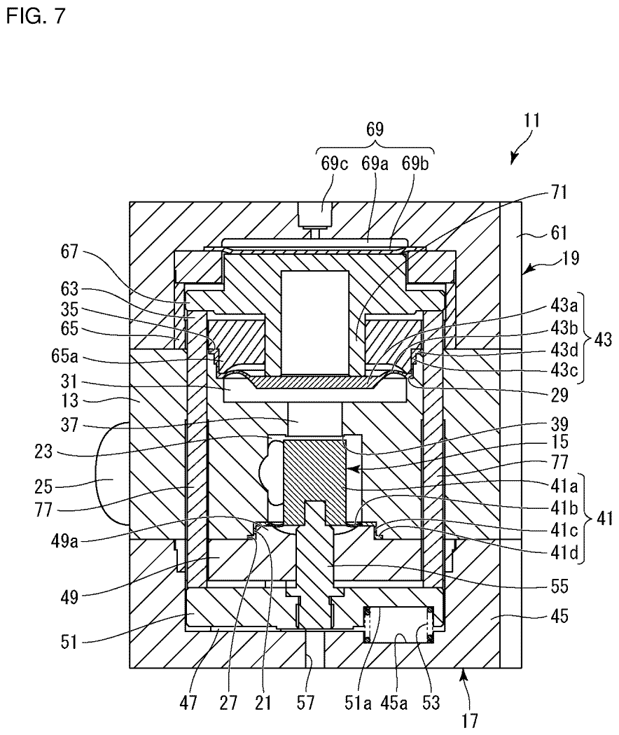

FIGS. 1 to 7 show an overall configuration of a linkage-type constant-pressure valve 11 according to one embodiment of the present invention. Referring to FIGS. 1 to 7, the linkage-type constant-pressure valve 11 includes a valve body 13, a valve mechanism 15 provided within the valve body 13, a first force-applying mechanism 17 attached to an upper part of the valve body 13, and a second force-applying mechanism 19 attached to a lower part of the valve body 13. The valve mechanism 15 is configured to open and close the constant-pressure valve 11 and to control a fluid pressure by adjusting a valve opening degree.

In the present embodiment, the valve body 13 is made of polytetrafluoroethylene (hereinafter referred to as PTFE). However, the valve body 13 may alternatively be made of other suitable materials, such as perfluoroalkoxyalkane (hereinafter referred to as PFA). Also, the valve body 13 may be manufactured from a resin joined body, in which a PFA molded body formed of PFA and a PTFE molded body formed of PTFE are joined by firing or other means. In this case, in order to suppress particles from being generated when a valve element portion 41a described later abuts against a valve seat 39, it is preferable that a portion including the valve seat 39 is made from the PFA molded body while the remaining portions are made from the PTFE molded body. There is continuously formed in the center of a lower portion of the valve body 13 a lower recess 21 of a planar circular shape and a first valve chamber 23 located above the center of the lower recess 21 and having a smaller diameter than the lower recess 21, and an inlet flow passage 25 is provided so as to be in communication with the first valve chamber 23. However, the reason why the first valve chamber 23 is formed to have the smaller diameter than the lower recess 21 is to facilitate fixing of a first diaphragm 41 described later to the lower recess 21, and the first valve chamber 23 need not have a smaller diameter than the lower recess 21 if there is no problem in fixing the first diaphragm 41. Further, the valve body 13 has an annular step portion 27 formed on a bottom surface thereof so as to surround the lower recess 21. On the other hand, there is continuously formed in the center of an upper portion of the valve body 13 an upper recess 29 of a planar circular shape and a second valve chamber 31 located below the center of the upper recess 29 and having a smaller diameter than the upper recess 29, and an outlet flow passage 33 is provided so as to be in communication with the second valve chamber 31. However, the reason why the second valve chamber 31 is formed to have the smaller diameter than the upper recess 29 is to facilitate fixing of a second diaphragm 43 described later to the upper recess 29, and the second valve chamber 31 need not have a smaller diameter than the upper recess 29 if there is no problem in fixing the second diaphragm 43. The valve body 13 further has an annular step portion 35 formed on a top surface thereof so as to surround the upper recess 29. Furthermore, there is a communication passage 37 formed in the valve body 13 so as to communicate the first valve chamber 23 and the second valve chamber 31 with each other, and the valve seat 39 is formed around an opening of the communication passage 37 to the first valve chamber 23.

The valve mechanism 15 is constituted by the first diaphragm 41 and the second diaphragm 43. In the shown embodiment, the first diaphragm 41 is made of PTFE and includes the valve element portion 41a, a membrane portion 41b extending outward from an outer periphery of a lower end of the valve element portion 41a, a cylindrical vertical support portion 41c provided at an outer peripheral edge of the membrane portion 41b and extending in the vertical direction in the figure, and an annular horizontal support portion 41d extending in the horizontal direction from an end (a lower end in the figure) of the vertical support portion 41c. The first diaphragm 41 is attached to the lower part of the valve body 13 by inserting the vertical support portion 41c along an inner peripheral surface of the lower recess 21 and causing the horizontal support portion 41d to be received in the annular step portion 27 of the valve body 13, with the valve element portion 41a disposed in the first valve chamber 23, thereby partitioning the first valve chamber 23 from the outside and supporting the valve element portion 41a disposed in the first valve chamber 23. The second diaphragm 43 is made of PTFE and includes a force-acting portion 43a, a membrane portion 43b extending outward from an outer periphery of the force-acting portion 43a, a cylindrical vertical support portion 43c provided at an outer peripheral edge of the membrane portion 43b and extending in the vertical direction, and an annular horizontal support portion 43d extending in the horizontal direction from an end (an upper end in the figure) of the vertical support portion 43c. The second diaphragm 43 is attached to the upper part of the valve body 13 by inserting the vertical support portion 43c along a peripheral wall of the upper recess 29 and causing the horizontal support portion 43d to be received in the annular step portion 35 of the valve body 13, with the force-acting portion 43a disposed in the second valve chamber 31, thereby partitioning the second valve chamber 31 from the outside and supporting the force-acting portion 43a disposed in the second valve chamber 31.

In the shown embodiment, the first diaphragm 41 is made entirely of PTFE, but is not limited thereto. For example, the first diaphragm 41 may be manufactured from a resin joined body, in which a PFA molded body formed of PFA and a PTFE molded body formed of PTFE are joined by firing or other means. In this case, in order to suppress particles from being generated when the valve element portion 41a abuts against the valve seat 39, it is preferable that a portion (a tip portion) of the valve element portion 41a of the first diaphragm 41 that abuts against the valve seat 39 is made from the PFA molded body while the remaining portions are made from the PTFE molded body.

The first force-applying mechanism 17 is attached to the lower part of the valve body 13 and functions to apply a force to the first diaphragm 41, which is attached to the first valve chamber 23 side of the valve body 13, in a direction to bring the valve element portion 41a of the first diaphragm 41 closer to the valve seat 39. The first force-applying mechanism 17 includes: a first mechanism housing body 45 having a recess formed therein; a first cover member 49 which closes an upper opening portion of the recess of the first mechanism housing body 45 to form a first mechanism accommodating chamber 47 therein; a first movable body 51 which can move within the first mechanism accommodating chamber 47 in the direction of approaching and separating from the communication passage 37 along a movement axis; a biasing member 53 which is provided within the first mechanism accommodating chamber 47 and biases the first movable body 51 in a direction to bring the first movable body 51 closer to the communication passage 37 along the movement axis; and a stem 55 extending from the first movable body 51 through the first cover member 49 so as to protrude to the outside from the first force-applying mechanism 17. The stem 55 is connected at the distal end thereof to the valve element portion 41a to the diaphragm 41 disposed in the first valve chamber 23. In the shown embodiment, the connection between the stem 55 and the valve element portion 41a is achieved by screwing, but may also be achieved by other methods such as press-fitting. The first mechanism housing body 45 and the first cover member 49 constitute a first mechanism housing. The first mechanism housing body 45 is provided with a vent port 57 so as to communicate with the first mechanism accommodating chamber 47, so that air in the first mechanism accommodating chamber 47 can enter and exit through the vent port 57. The first movable body 51 is biased by the biasing member 53 in a direction to approach the communication passage 37. Accordingly, as the first movable body 51 moves within the first mechanism accommodating chamber 47 along the inner peripheral surface of the first mechanism accommodating chamber 47 in the direction of the movement axis under a biasing force of the biasing member 53, a force in the direction in which the valve element portion 41a of the first diaphragm 41 connected to the tip of the stem 55 of the first movable body 51 is pressed against the valve seat 39 is always applied.

In the shown embodiment, the first movable body 51 has a substantially disk shape, and the outer peripheral surface of the first movable body 51 slides against the inner peripheral surface of the first mechanism accommodating chamber 47 to guide the first movable body 51 to move in the direction of the movement axis. Also, in the shown embodiment, a coil spring is used as the biasing member 53, which is disposed so as to be held between a concave spring seat 51a formed on a bottom surface of the first movable body 51 and a concave spring seat 45a formed on a bottom surface of the recess portion of the first mechanism housing body 45 (i.e., a bottom surface of the first mechanism accommodating chamber). Further, in the shown embodiment, the vent port 57 is provided on the bottom surface of the first mechanism housing body 45. However, the configuration of the linkage-type constant-pressure valve 11 is not limited to that of the shown embodiment. The first movable body 51 may have a shape other than a disk shape, such as a polygonal plate shape or an elliptical plate shape. The biasing member may also be constituted by other members such as an elastic body. The vent port 57 may also be provided at a location other than the bottom surface, such as the side surface of the recess of the first mechanism housing body 45.

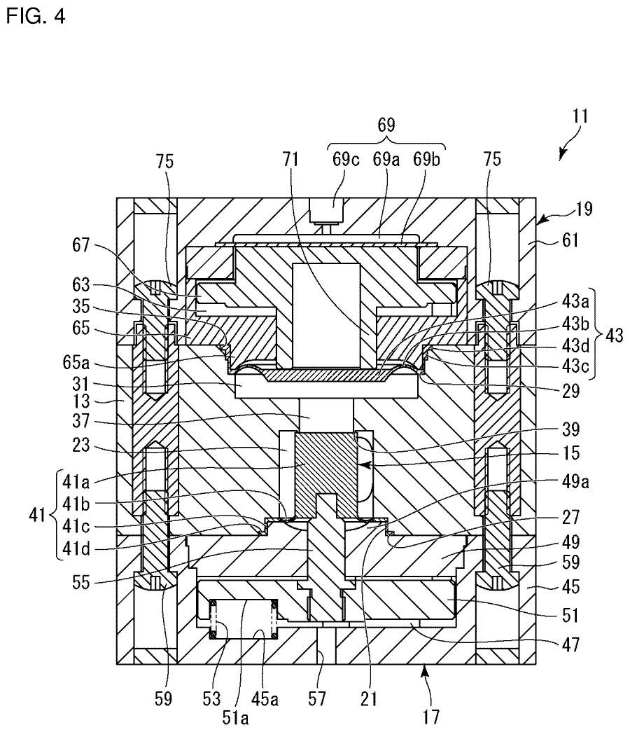

The first cover member 49 is formed with a protrusion portion 49a which extends to protrude toward the valve body 13. When the first force-applying mechanism 17 is attached to the valve body 13, the protrusion portion 49a of the first cover member 49 is inserted into the lower recess 21 of the valve body 13, so that the vertical support portion 41c of the first diaphragm 41 attached to the lower recess 21 of the valve body 13 is held between the inner peripheral surface of the lower recess 21 and an outer peripheral surface of the protrusion portion 49a of the first cover member 49, and the horizontal support portion 41d of the first diaphragm 41 is held between the step portion 27 of the valve body 13 and a top surface of the first cover member 49 surrounding the protrusion portion 49a. In this state, as shown in FIG. 4, the first force-applying mechanism 17 is fixed to the valve body 13 using fasteners 59, thereby securing the first diaphragm 41 to the valve body 13 and supporting the valve element portion 41a within the first valve chamber 23.

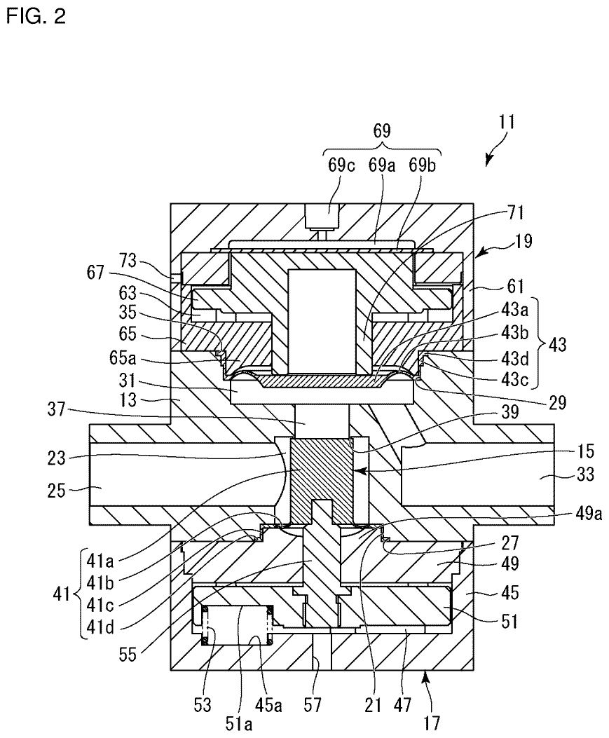

The second force-applying mechanism 19 is attached to the upper part of the valve body 13 and functions to apply an adjustable predetermined force to the second diaphragm 43, which is attached to the second valve chamber 31 side of the valve body 13, in a direction to bring the force-acting portion 43a of the second diaphragm 43 closer to the communication passage 37. The second force-applying mechanism 19 includes: a second mechanism housing body 61 having a recess portion formed therein; a second cover member 65 which closes a lower opening portion of the recess portion of the second mechanism housing body 61 to form a second mechanism accommodating chamber 63 therein; a second movable body 67 which can move within the second mechanism accommodating chamber 63 in the direction of approaching and separating from the communication passage 37 along the movement axis; an applied force adjustment mechanism 69 which applies an adjustable predetermined force to the second movable body 67 in a direction to bring the second movable body 67 closer to the communication passage 37 along the movement axis; and a force transmission portion 71 which extends from the second movable body 67 through the second cover member 65 so as to protrude to the outside from the second force-applying mechanism 19. In this embodiment, the force transmission portion 71 is not connected to the force-acting portion 43a, but instead is configured such that a tip thereof is in contact with the force-acting portion 43a of the second diaphragm 43 to pressurize the force-acting portion 43a in a direction to bring the force-acting portion 43a closer to the communication passage 37, thereby applying a force to the second diaphragm 43 (specifically, the force-acting portion 43a thereof). Also, in this embodiment, the force transmission portion 71 is formed integrally with the second movable body 67, but the force transmission portion 71 may be formed as a separate component and connected to the second movable body 67 by screwing or other means. The second mechanism housing body 61 and the second cover member 65 constitute a second mechanism housing. The second mechanism housing body 61 is provided with a vent port 73 (see FIG. 2) so as to communicate with the second mechanism accommodating chamber 63, so that air in the second mechanism accommodating chamber 63 can enter and exit through the vent port 73. The second diaphragm 43 is in contact with the fluid in the second valve chamber 31 and comes into contact with the force transmission portion 71 extending from the second movable body 67. As a result, the fluid pressure which acts on the second diaphragm 43 from the fluid in the second valve chamber 31 is applied to the second movable body 67 via the force transmission portion 71 in a direction to move the second movable body 67 away from the second valve chamber 31, i.e., in a direction to separate the second movable body 67 from the communication passage 37, and an adjustable constant force is applied to the second movable body 67 from the applied force adjustment mechanism 69 in a direction to bring the second movable body 67 closer to the communication passage 37. The force applied from the applied force adjustment mechanism 69 to the second movable body 67 is adjusted to be greater than or equal to the fluid pressure applied from the fluid in the second valve chamber 31 to the second movable body 67 via the second diaphragm 43 and the force transmission portion 71, so that a resultant force in a direction to bring the second movable body 67 closer to the communication passage 37 acts on the second movable body 67.

In this embodiment, the second movable body 67 has a substantially disk shape, and the outer peripheral surface of the second movable body 67 slides against the inner peripheral surface of the second mechanism accommodating chamber 63 to guide the second movable body 67 to move in the direction of the movement axis. Also, in this embodiment, the applied force adjustment mechanism 69 is constituted by a pressurizing fluid chamber 69a provided continuously with the second mechanism accommodating chamber 63, and a pressurizing diaphragm 69b disposed adjacent to the pressurizing fluid chamber 69a so as to partition the pressurizing chamber 69a and the second mechanism accommodating chamber 63 from each other. The pressurizing fluid chamber 69a is supplied with a pressurizing fluid through a pressurizing fluid supply port 69c, and the pressure of the pressurizing fluid in the pressurizing fluid chamber 69a is applied to the second movable body 67 in a direction to bring the second movable body 67 closer to the communication passage 37 via the pressurizing diaphragm 69b disposed in contact with the second movable body 67. The pressurizing force applied to the second movable body 67 can be adjusted by adjusting the supply amount of the pressurizing fluid. However, as long as the applied force adjustment mechanism 69 is capable of applying an adjustable constant force to the second movable body 67, it is not limited to the configuration of the shown embodiment. For example, the applied force adjustment mechanism 69 may be configured by a cylinder mechanism that directly presses the second movable body 67. Further, as long as the applied force adjustment mechanism 69 is capable of applying a force to the second movable body 67, it does not need to apply a force directly to the second movable body 67, but may be configured to apply the force to the second movable body 67 indirectly.

The second cover member 65 is formed with a protrusion portion 65a which extends to protrude toward the valve body 13. When the second force-applying mechanism 19 is attached to the valve body 13, the protrusion portion 65a of the second cover member 65 is inserted into the upper recess 29 of the valve body 13, so that the vertical support portion 43c of the second diaphragm 43 attached to the upper recess 29 of the valve body 13 is held between an inner peripheral surface of the upper recess 29 and an outer peripheral surface of the protrusion portion 65a of the second cover member 65, and the horizontal support portion 43d of the second diaphragm 43 is held between the step portion 35 of the valve body 13 and a bottom surface of the second cover member 65 surrounding the protrusion portion 65a. In this state, as shown in FIG. 4, the second force-applying mechanism 19 is fixed to the valve body 13 using fasteners 75, thereby securing the second diaphragm 43 to the valve body 13 and supporting the force-acting portion 43a within the second valve chamber 31.

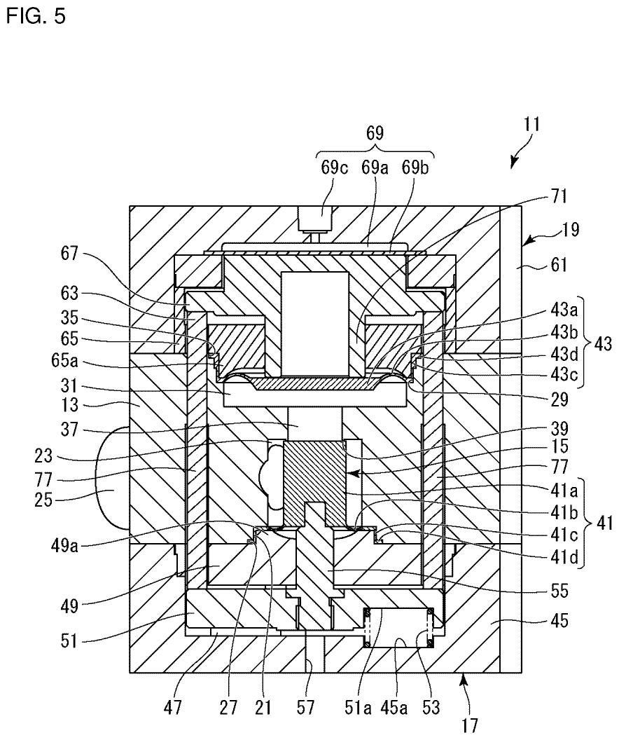

Between the first movable body 51 and the second movable body 67, as shown for example in FIG. 5, a link member 77, which extends through the outside of the first valve chamber 23, the communication passage 37, and the second valve chamber 31 in the valve body 13 and is movable in the direction of the movement axis, is further provided. In the shown embodiment, one end of the link member 77 is in contact with an upper surface of the first movable body 51 in a separable manner, while the other end thereof is in contact with the second movable body 67 in a separable manner. The first movable body 51 and the second movable body 67 are disposed on opposite sides of the communication passage 37. As described above, the first movable body 51 is biased in a direction to approach the communication passage 37 by the biasing force of the biasing member 53, and the second movable body 67 is applied with a force in a direction to approach the communication passage 37 by the resultant force of the fluid pressure applied from the fluid in the second valve chamber 31 via the second diaphragm 43 and the force transmission portion 71 and the predetermined force applied by the applied force adjustment mechanism 69. That is, the first movable body 51 and the second movable body 67 are applied with a force in a direction to approach each other.

Therefore, the link member 77 is held between the first movable body 51 and the second movable body 67, enabling the transmission of force therebetween via the link member 77. In the shown embodiment, the four link members 77 are provided between the first movable body 51 and the second movable body 67. However, as long as the link member 77 can transmit force between the first movable body 51 and the second movable body 67, a single link member may be provided, or a plurality of link members may be provided. For balanced force transmission between the first movable body 51 and the second movable body 67, it is preferable to provide the multiple link members 77 between the first movable body 51 and the second movable body 67.

As described above, the first movable body 51 and the second movable body 67 transmit forces to each other via the link member 77. As a result, the second movable body 67 comes to a halt at a position where three forces, i.e., the adjustable constant pressurizing force applied to the second movable body 67 by the applied force adjustment mechanism 69, the fluid pressure acting on the second diaphragm 43 from the fluid in the second valve chamber 31 and applied to the second movable body 67 via the force transmission portion 71, and the biasing force acting on the first movable body 51 from the biasing member 53 and applied to the second movable body 67 via the link member 77 are balanced. When the position of the second movable body 67 is determined, the position of the first movable body 51 is also defined via the link member 77, and the position of the valve element portion 41a connected to the first movable body 51 via the stem 55 is determined.

Accordingly, with the adjustment of the predetermined force applied to the second movable body 67 by the applied force adjustment mechanism 69, it is possible to change the equilibrium position of the three forces acting on the second movable body 67, thereby causing the first movable body 51 to move in response to the movement of the second movable body 67. As a result, a gap (i.e., an opening area) between the valve seat 39 and the valve element portion 41a connected to the first movable body 51 via the stem 55 is varied, allowing the valve opening degree to be adjusted.

Even when the pressure of the fluid in the second valve chamber 31 changes, the equilibrium position of the three forces acting on the second movable body 67 is changed, thereby causing the first movable body 51 to move in response to the movement of the second movable body 67. As a result, the gap between the valve element portion 41a and the valve seat 39 changes, and hence the flow rate of the fluid flowing from the first valve chamber 23 into the second valve chamber 31 through the communication passage 37 is changed so as to cancel the change in fluid pressure as described later.

Further, the first movable body 51 and the second movable body 67 are moved in conjunction with each other via the link member 77, which extends through the outside of the first valve chamber 23, the communication passage 37, and the second valve chamber 31 in the valve body 13. The second diaphragm 43 is moved in conjunction with the second movable body 67 via the force transmission portion 71, and the valve element portion 41a is moved in conjunction with the first movable body 51 via the stem 55, thereby changing the position of the valve element portion 41a relative to the valve seat 39 in accordance with the change in the pressure of the fluid within the second valve chamber 31. In addition, the connection part between the stem 55 and the valve element portion 41a is located on the opposite side of a fluid contact region. Therefore, the first diaphragm 41 and the first movable body 51, and the second diaphragm 43 and the second movable body 67 are moved in conjunction with each other without requiring the connection part for moving the two in conjunction with each other to be provided within the fluid contact region. This eliminates the need for connecting work such as threading in the fluid contact region, enabling assembly without concerns about contamination of the parts located within the fluid contact region, making the assembly easier, and making it possible to prevent the generation of particles caused by the connection parts within the fluid contact region. Further, since there is no need to provide a connecting member for moving the second diaphragm 43 and the valve element portion 41 in conjunction with each other so as to penetrate into the communication passage 37, the fluid in the fluid contact region can easily flow through the communication passage 37. This, in turn, suppresses fluid retention, thereby making it possible to achieve the effect of improving the accuracy of flow rate control.

In addition, as described above, the link member 77 is held between the first movable body 51 and the second movable body 67, and as long as force can be transmitted between the first movable body 51 and the second movable body 67 via the link member 77, there is no need to fix both ends of the link member 77 to the first movable body 51 and the second movable body 67, respectively. Therefore, the link member 77 can be made to be held between the first movable body 51 and the second movable body 67 by modularizing the first force-applying mechanism 17 and the second force-applying mechanism 19 as independent, separate units, and simply attaching the first force-applying mechanism 17 and the second force-applying mechanism 19 to the top and bottom of the valve body 13 with the link member 77 passed therethrough. This enables the linkage-type constant-pressure valve 11 to be easily assembled.

Note that in present embodiment, the pressurizing diaphragm 69b of the applied force adjustment mechanism 69, the first mechanism housing body 45, the first cover member 49, and the first movable body 51 of the first force-applying mechanism 17, as well as the second mechanism housing body 61, the second cover member 65, and the second movable body 67 of the second force-applying mechanism 19, are made of PTFE, and the link member 77 is made of polyvinylidene fluoride (hereinafter referred to as PVDF). However, these components, including other components of the linkage-type constant-pressure valve 11 described above, may be made of any other appropriate materials and are not particularly limited. For example, the link member 77 may be made of a metal material.

Next, the operation of the linkage-type constant-pressure valve 11 will be described. In the linkage-type constant-pressure valve 11, when no force is applied to the second movable body 67 by the applied force adjustment mechanism 69, the second movable body 67 receives a force in a direction to move the second movable body 67 away from the communication passage 37 due to the fluid pressure applied from the fluid in the second valve chamber 31 through the second diaphragm 43 and the force transmission portion 71, and the biasing force applied to the first movable body 51 by the biasing member 53 and transmitted via the link member 77. Thus, the second movable body 67 can move in a direction away from the communication passage 37 along the movement axis. In conjunction with this, the first movable body 51 also moves in the same direction along the movement axis via the link member 77, and the valve element portion 41a of the first diaphragm 41 is pushed upward via the stem 55 and pressed against the valve seat 39. At this time, since the communication passage 37 is closed by the valve element portion 41a, the fluid does not flow from the first valve chamber 23 to the second valve chamber 31, thereby resulting in a valve closed state.

When a predetermined force is applied to the second movable body 67 by the applied force adjustment mechanism 69 from this state, the second movable body 67 is pushed by the applied force in a direction to approach the communication passage 37 along the movement axis, and overcomes the biasing force of the biasing member 53 acting on the first movable body 51 and transmitted to the second movable body 67 via the link member 77, to move along the movement axis in the direction to approach the communication passage 37, i.e., toward the first movable body 51. Since the link member 77 is disposed between the first movable body 51 and the second movable body 67, when the second movable body 67 attempts to approach the first movable body 51 along the movement axis, the first movable body 51 is moved along the movement axis in the direction to move away from the communication passage 37 with the link member 77 interposed between the first movable body 51 and the second movable body 67. As a result, the valve element portion 41a of the first diaphragm 41, which is connected to the first movable body 51 via the stem 55, moves away from the valve seat 39, allowing the fluid to flow into the communication passage 37 through the gap between the valve element portion 41a and the valve seat 39, and the fluid begins to flow from the first valve chamber 23 to the second valve chamber 31.

When the fluid flows into the second valve chamber 31, the fluid pressure acting on the second diaphragm 43 in a direction away from the communication passage 37 along the movement axis due to the fluid in the second valve chamber 31 is applied to the second movable body 67 via the force transmission portion 71. In the shown embodiment, the pressure acting on the second diaphragm 43 in a direction away from the communication passage 37 along the movement axis due to the fluid in the second valve chamber 31 is transmitted to the second movable body 67 via the force transmission portion 71, which is in contact with the second diaphragm 43. If the force applied by the applied force adjustment mechanism 69 to the second movable body 67 in a direction to bring the second movable body 67 closer to the communication passage 37 along the movement axis is adjusted to be greater than or equal to the fluid pressure applied to the second movable body 67 from the fluid in the second valve chamber 31 via the second diaphragm 43 and the force transmission portion 71 in the direction away from the communication passage 37 along the movement axis, then the resultant force of the two forces applied to the second movable body 67 from the applied force adjustment mechanism 69 and the fluid in the second valve chamber 31, i.e., the resultant force of the force applied by the applied force adjustment mechanism 69 and the fluid pressure due to the fluid in the second valve chamber 31 will act in a direction to bring the second movable body 67 closer to the communication passage 37 along the movement axis, i.e., in a direction to bring the second movable body 67 closer to the first movable body 51 along the movement axis. On the other hand, the first movable body 51 is always biased by the biasing member 53 in a direction to bring the first movable body 51 closer to the communication passage 37 along the movement axis, i.e., in a direction to bring the first movable body 51 closer to the second movable body 67 along the movement axis. Therefore, the first movable body 51 and the second movable body exert forces on each other via the link member 77 in the direction to approach each other, and are held together with the link member 77 sandwiched in between, to move integrally as if they were connected via the link member 77. As a result, the first movable body 51 and the second movable body 67 come to a halt at a position where the resultant force of the two forces acting on the second movable body 67 in opposite directions, i.e., the resultant force of the force acting on the second movable body 67 by the applied force adjustment mechanism 69 in a direction to approach bring the second movable body 67 closer to the communication passage 37 and the fluid pressure acting on the second movable body 67 from the fluid in the second valve chamber 31 via the second diaphragm 43 and the force transmission portion 71 in a direction away from the communication passage 37, and the biasing force acting on the first movable body 51 from the biasing member 53 are balanced.

In a state where the communication passage 37 is in a valve open state and fluid is flowing into the second valve chamber 31, when the pressure of the upstream fluid, i.e., the pressure of the fluid in the first valve chamber 23, increases and consequently the pressure of the fluid in the second valve chamber 31 increases, the fluid pressure acting on the second diaphragm 43 from the fluid in the second valve chamber 31, which is one of the forces acting on the second movable body 67, increases, and the resultant force acting on the second movable body 67 in the opposite direction to the biasing force applied to the first movable body 51 by the biasing member 53 decreases. As a result, the biasing force applied to the first movable body 51 from the biasing member 53 overcomes the resultant force applied to the second movable body 67, so that the first movable body 51 moves in a direction toward the communication passage 37, and the valve element portion 41a approaches the valve seat 39 via the stem 55. This reduces the gap (i.e., the opening area) between the valve element portion 41a and the valve seat 39, thereby causing the valve opening degree to be smaller. As a result, the flow rate of the fluid flowing from the first valve chamber 23 into the second valve chamber 31 through the communication passage 37 is reduced, and the pressure in the second valve chamber 31 is decreased.

Conversely, in a state where the communication passage 37 is in a valve open state and fluid is flowing into the second valve chamber 31, when the pressure of the upstream fluid, i.e., the pressure of the fluid in the first valve chamber 23, decreases and consequently the pressure of the fluid in the second valve chamber 31 decreases, the fluid pressure acting on the second diaphragm 43 from the fluid in the second valve chamber 31 decreases, and the resultant force on the second movable body 67 in the opposite direction to the biasing force applied to the first movable body 51 by the biasing member 53 increases. As a result, the resultant force applied to the second movable body 67 overcomes the biasing force applied to the first movable body 51 from the biasing member 53, so that the first movable body 51 moves in a direction away from the communication passage 37, and the valve element portion 41a is separated from the valve seat 39 via the stem 55. This increases the gap (i.e., the opening area) between the valve element portion 41a and the valve seat 39, thereby causing the valve opening degree to be larger. As a result, the flow rate of the fluid flowing from the first valve chamber 23 into the second valve chamber 31 through the communication passage 37 increases, and the pressure in the second valve chamber 31 is increased.

In either case, the first movable body 51 and the second movable body 67 come to a halt at a position where the resultant force of the two forces applied to the second movable body 67 from the applied force adjustment mechanism 69 and the fluid in the second valve chamber 31 and the biasing force acting on the first movable body 51 from the biasing member 53 are balanced. If the force applied to the second movable body 67 by the applied force adjustment mechanism 69 does not change significantly, then the force applied to the second diaphragm 43 by the applied force adjustment mechanism 69 via the force transmission portion 71 remains unchanged. Accordingly, the fluid pressure acting on a lower surface of the second diaphragm 43 from the fluid in the second valve chamber 31 remains substantially the same as the pressure before any increase or decrease in upstream pressure. In the shown embodiment, if the pressure of the pressurizing fluid in the pressurizing fluid chamber 69a of the applied force adjustment mechanism 69 does not change significantly, then the force applied to an upper surface of the second diaphragm 43 by the applied force adjustment mechanism 69 remains unchanged. Accordingly, the fluid pressure acting on the lower surface of the second diaphragm 43 from the fluid in the second valve chamber 31 remains substantially the same as the pressure before any increase or decrease in upstream pressure.

Thus, when the pressure of the upstream fluid changes and the pressure in the second valve chamber 31 increases or decreases, the resultant force of the two forces acting on the second movable body 67 also changes to thereby change the positions of the first movable body 51 and the second movable body 67, which are in balance with the force acting on the first movable body 51, thus moving the valve element portion 41a relative to the valve seat 39 in a direction to suppress a change in the pressure of the fluid in the second movable body 67 located on the downstream side. As a result, even if the pressure of the upstream fluid fluctuates, the pressure of the fluid in the second valve chamber 31 can be kept substantially constant.

In the applied force adjustment mechanism 69 of the embodiment shown in FIGS. 1 to 7, the force is applied directly to the second movable body 67 through the pressurizing diaphragm 69b by the pressurizing fluid supplied to the pressurizing fluid chamber 69a, and the force acting on the second movable body 67 is then applied to the second movable body 67 via the force transmission portion 71 which is in contact with the force acting-portion 43a. However, as long as the applied force adjustment mechanism 69 can apply the force to the second movable body 67 and the second force-applying mechanism 19 can apply the force to the second diaphragm 43, the configurations of the second force-applying mechanism 19 and the applied force adjustment mechanism 69 are not limited to the embodiment shown in FIGS. 1 to 7.

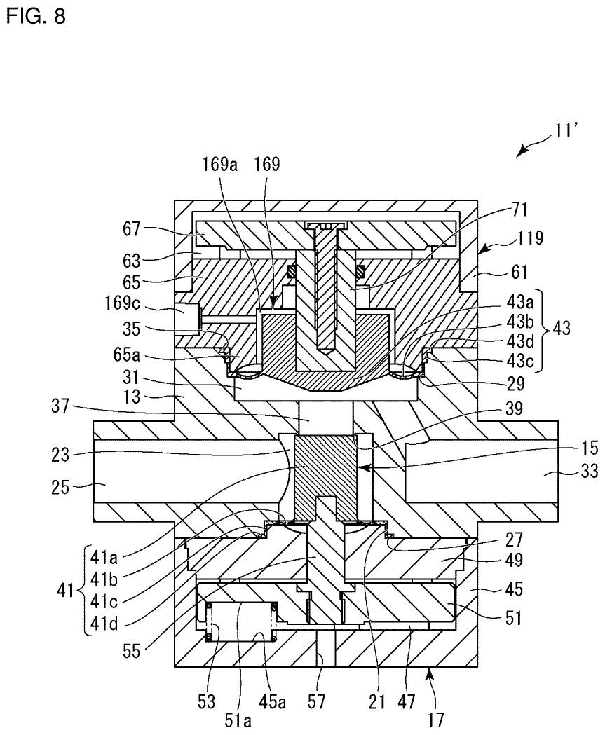

FIG. 8 shows a linkage-type constant-pressure valve 11′ according to another embodiment, which is provided with a second force-applying mechanism 119 having an applied force adjustment mechanism 169 configured differently from that of the linkage-type constant-pressure valve 11 of the embodiment shown in FIGS. 1 to 7. The embodiment shown in FIG. 8 is common in configuration to the embodiment shown in FIGS. 1 to 7, except for the second force-applying mechanism 119, and the components common to those of FIGS. 1 to 7 are denoted by the same reference numerals in FIG. 8. In the following, the second force-applying mechanism 119 will be mainly described, and a description of the common components will be omitted.

In the linkage-type constant-pressure valve 11 according to the embodiment shown in FIGS. 1 to 7, the applied force adjustment mechanism 69 is constituted by the pressurizing fluid chamber 69a provided continuously with the second mechanism accommodating chamber 63, and the pressurizing diaphragm 69b disposed adjacent to the pressurizing fluid chamber 69a so as to partition the pressurizing fluid chamber 69a from the second mechanism accommodating chamber 63. In addition, the force transmission portion 71 presses the second diaphragm 43 simply by being in contact with the force-acting portion 43a of the second diaphragm 43, so that the force applied to the second movable body 67 by the applied force adjustment mechanism 69 is transmitted to the second diaphragm 43 via the force transmission portion 71.

In contrast to this, in the linkage-type constant-pressure valve 11′ according to the embodiment shown in FIG. 8, the applied force adjustment mechanism 169 is constituted by a pressurizing fluid chamber 169a provided on a surface of a second mechanism housing (specifically, a second cover member 65) facing a second diaphragm 43, and a pressurizing fluid supply port 169c provided in the second mechanism housing (specifically, the second cover member 65) to supply and discharge a pressurizing fluid to and from the pressurizing fluid chamber 169a. Specifically, the pressurizing fluid chamber 169a is formed by covering, with the second diaphragm 43, a recessed portion provided on the surface of the second cover member 65 facing the second diaphragm 43 when the second force-applying mechanism 119 is attached to a valve body 13. Further, a force transmission portion extending from a second movable body 67 is connected to a force-acting portion 43a of the second diaphragm 43, so that the force-acting portion 43a of the second diaphragm 43 and the second movable body 67 move in conjunction with each other, and a force is transmitted between the second diaphragm 43 and the second movable body 67 via the force transmission portion 71.

With such a configuration, when the pressure of the pressurizing fluid supplied to the pressurizing fluid chamber 169a through the pressurizing fluid supply port 169c acts on the surface of the second diaphragm 43 opposite to the second valve chamber 31, a force directed to bring the force-acting portion 43a of the second diaphragm 43 closer to a communication passage 37 along the movement axis is applied to the second movable body 67 via the force transmission portion 71. Therefore, the force applied to the second movable body 67 in the direction to bring the force-acting portion 43a of the second diaphragm 43 closer to the communication passage 37 along the movement axis can be adjusted by adjusting the amount of the pressurizing fluid to be supplied through the pressurizing fluid supply port 169c. This makes it possible to function as the applied force adjustment mechanism 169.

The action of the applied force adjustment mechanism 169 in the embodiment shown in FIG. 8 is common to the action of the applied force adjustment mechanism 69 in the embodiment shown in FIGS. 1 to 7 in that the adjustable predetermined force is applied to the second movable body 67 in the direction to bring the second movable body 67 closer to the communication passage 37 along the movement axis. Accordingly, the operation of the linkage-type constant-pressure valve 11′ according to the embodiment shown in FIG. 8 is similar to the operation of the linkage-type constant-pressure valve 11 according to the embodiment shown in FIGS. 1 to 7, and a description thereof will be omitted here. On the other hand, since the applied force adjustment mechanism 169 of the linkage-type constant-pressure valve 11′ according to the embodiment shown in FIG. 8 is capable of directly applying a force to the second diaphragm 43, it can achieve the effect of being capable of improving the responsiveness to pressure changes of the fluid in the second valve chamber 31 as compared with the linkage-type constant-pressure valve 11. Further, since the force-acting portion 43a of the second diaphragm 43 and the second movable body 67 are connected to each other via the force transmission portion 71, it is possible to further improve the responsiveness to the pressure changes of the fluid in the second valve chamber 31.

Although the linkage-type constant-pressure valve according to the present invention has been described above with reference to the shown embodiments, the present invention is not limited to the shown embodiments. For example, in the shown embodiment, the coil spring is used as the biasing member 53 of the first force-applying mechanism 17, but it is also possible to use an elastic body, an operating fluid, a combination of an operating fluid and a coil spring, etc., as the biasing member 53. Also, the operating fluid is used to apply force to the second diaphragm 43 in the applied force adjustment mechanism 69 of the second force-applying mechanism 19, but it is also possible to use an elastic body, a coil spring, a combination of an operating fluid and a coil spring, etc., instead of the operating fluid. Any combination of the biasing member 53 and the applied force adjustment mechanism 69 may be employed.

Further, both ends of the link member 77 may be fixed to the first movable body 51 and the second movable body 67, for example, by adhesion or the like. However, when a plurality of link members 77 are provided between the first movable body 51 and the second movable body 67, it is preferable that both ends of the link members 77 are in contact with the first movable body 51 and the second movable body 67 in a separable manner, in order to allow for differences in length between the link members 77.

### Description of Reference Numerals

11 linkage-type constant-pressure valve
11′ linkage-type constant-pressure valve
13 valve body
15 valve mechanism
17 first force-applying mechanism
19 second force-applying mechanism
23 first valve chamber
25 inlet flow passage
31 second valve chamber
33 outlet flow passage
37 communication passage
39 valve seat
41 first diaphragm
41a valve element portion
43 second diaphragm
45 first mechanism housing body
47 first mechanism accommodating chamber
49 first cover member
51 first movable body
53 biasing member
55 stem
61 second mechanism housing body
63 second mechanism accommodating chamber
65 second cover member
67 second movable body
69 applied force adjustment mechanism
71 force transmission portion
77 link member
119 second force-applying mechanism
169 applied force adjustment mechanism

1. A linkage-type constant-pressure valve comprising: a valve body formed with a first valve chamber being in communication with an inlet flow passage, a second valve chamber being in communication with an outlet flow passage, and a communication passage communicating the first valve chamber and the second valve chamber with each other; a valve seat formed in the communication passage; a valve mechanism including a first diaphragm attached to the valve body so as to face the first valve chamber and supporting a valve element portion movable in a direction of a movement axis relative to the valve seat, and a second diaphragm attached to the valve body so as to face the second valve chamber; a first force-applying mechanism attached to the valve body and applying a force to the first diaphragm in a direction to bring the valve element portion closer to the valve seat; and a second force-applying mechanism attached to the valve body and applying a predetermined force in a direction to bring the second diaphragm closer to the communication passage, said valve element portion moved relative to the valve seat in accordance with the pressure of a fluid in the second valve chamber,
wherein the first force-applying mechanism comprises a first mechanism housing having a first mechanism accommodating chamber formed therein, a first movable body accommodated in the first mechanism accommodating chamber and movable in the direction of the movement axis, a biasing member provided in the first mechanism accommodating chamber and biasing the first movable body in a direction to approach the communication passage, and a stem extending from the first movable body through the first mechanism housing and connected to the valve element portion of the first diaphragm,
wherein the second force-applying mechanism comprises a second mechanism housing having a second mechanism accommodating chamber formed therein, a second movable body accommodated in the second mechanism accommodating chamber and movable in the direction of the movement axis, an applied force adjustment mechanism applying an adjustable predetermined force to the second movable body in a direction to approach the communication passage, and a force transmission portion extending from the second movable body through the second mechanism housing and transmitting a force between the second movable body and the second diaphragm, and
wherein a rod-shaped link member is provided so as to be arranged between the first movable body and the second movable body and extend through the valve body outside the first valve chamber and the second valve chamber in the direction of the movement axis, so that the first movable body and the second movable body are moved in conjunction with each other via the link member.

2. The linkage-type constant-pressure valve according to claim 1, wherein the applied force adjustment mechanism is configured to apply to the second movable body a force greater than or equal to the pressure exerted by the fluid in the second valve chamber on the second diaphragm.

3. The linkage-type constant-pressure valve according to claim 1, wherein a plurality of link members extend between the first movable body and the second movable body.

4. The linkage-type constant-pressure valve according to claim 1, wherein the force transmission portion is configured to come in contact with the second diaphragm and transmit force between the second movable body and the second diaphragm.

5. The linkage-type constant-pressure valve according to claim 4, wherein the applied force adjustment mechanism includes a pressurizing fluid chamber and a pressurizing diaphragm provided adjacent to the pressurizing fluid chamber, and is configured to make the pressure of a pressurizing fluid adjustably supplied into the pressurizing fluid chamber to act on the second movable body via the pressurizing diaphragm.

6. The linkage-type constant-pressure valve according to claim 5, wherein the pressurizing fluid comprises compressed air.

7. The linkage-type constant-pressure valve according to claim 1, wherein the force transmission portion is connected to the second diaphragm.

8. The linkage-type constant-pressure valve according to claim 7, wherein the applied force adjustment mechanism includes a recess provided on a surface of the second mechanism housing facing the second diaphragm, and the second diaphragm covers the recess to form a pressurizing fluid chamber when the second force-applying mechanism is attached to the valve body, and fluid pressure acting on the second diaphragm by pressurizing fluid adjustably supplied to the pressurizing fluid chamber is applied to the second movable body via the force transmission portion.

9. The linkage-type constant-pressure valve according to claim 8, wherein the pressurizing fluid comprises compressed air.

10. The linkage-type constant-pressure valve according to claim 1, wherein the biasing member comprises a coil spring.

11. The linkage-type constant-pressure valve according to claim 1, wherein the link member is held between the first movable body and the second movable body to be able to come into and out of contact with the first movable body and the second movable body.

12. The linkage-type constant-pressure valve according to claim 1, wherein both ends of the link member are fixed to the first movable body and the second movable body, respectively.
